(19) United States
(12) Patent Application Publication
(10) Pub. No.: US 2008/0170117 A1
(43) Pub. Date: Jul. 17, 2008

(54) SYSTEM FOR VOICE INTERCEPTION OF VIDEO PHONE SERVICES IN A MULTI-MEDIA NETWORK

(75) Inventor: Futao Xiao, Shenzhen (CN)

Correspondence Address: AKIN GUMP STRAUSS HAUER & FELD, LLP, P O BOX 688, DALLAS, TX, 75313-0688, US

(73) Assignee: Huawei Technologies Co., Ltd., Shenzhen (CN)

(21) Appl. No.: 11/622,134

(22) Filed: Jan. 11, 2007

(51) Int. Cl. H04N 7/14

(52) U.S. Cl. 348/14.12; 348/E07.054

(57) ABSTRACT

A system for carrying out voice interception for Video Phone (VP) services in a Wideband Code Division Multiple Access (WCDMA) network. The system receives an interception request to perform interception on a target and interception related information from a Law Enforcement Agency (LEA), processes communication traffic of the intercept target to obtain audio data from the communication traffic, converts the audio data into a format that is supported by the LEA, and delivers the audio data to the LEA.

### TECHNICAL FIELD OF THE INVENTION

The present invention relates generally to interception of multi-media communications, and more particularly, the present invention relates to a versatile system for voice interception of video phone services in a multi-media communications network.

### BACKGROUND OF THE INVENTION

Lawfully authorized interception and monitoring of communications of an intercept target has been used and is needed by a country to protect public safety and national security. Rapid development in telecommunication services, however, makes call interception more difficult using conventional methods, and therefore, new interception strategies for modern telecommunication networks are needed. Conventionally, interception methods in Circuit Switched (CS) fields mainly target voice interception, where voice streams on a Media Gateway (MGW) are duplicated, and sent to an intercept request source through relay E1. An intercept request source is an entity authorized to intercept communications and receive intercept results. An example of an intercept request source is a Law Enforcement Agency (LEA). However, interception interfaces of different intercept request sources vary from country to country. For example, most LEAs support Time Division Multiplexing (TDM), and some provide Internet Protocol (IP) interfaces.

In multi-media networks, such as a Wideband Code Division Multiple Access (WCDMA) network, where Video Phone (VP) services are introduced and implemented with 64 Kbit/s Unrestricted Digital Information (UDI) bearer capacity, video, audio and control information are all transmitted through one channel. Conventionally, however, there is no interception standard for VP services in a WCDMA network. Furthermore, only voice interception may be performed in conventional LEAs.

Therefore, there is a need to carry out voice interception for VP services in a multi-media network, and to accommodate the conventional intercept request sources, such as LEAs.

### SUMMARY OF THE INVENTION

The present invention includes a system, comprising various constructs and methods, for voice interception of Video Phone (VP) services in a multi-media network. Responsive to an interception request to perform interception on a target and interception related information, from a Law Enforcement Agency (LEA), the system processes communication traffic of the intercept target, to obtain audio data from the communication traffic, if the intercept target is communicating via a VP call; converts the audio data into a format that is supported by the LEA; and delivers the audio data to the LEA.

The present invention carries out voice interception for VP services without the need to introduce changes in conventional LEAs.

The following description and drawings set forth in detail a number of illustrative embodiments of the invention. These embodiments are indicative of but a few of the various ways in which the present invention may be utilized.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a diagram illustrating a conventional method of carrying out Video Phone (VP) interception in a Circuit Switched (CS) field;

FIG. 2 is a diagram illustrating an embodiment of carrying out VP interception in a CS field according to the present invention;

FIG. 3 is a diagram illustrating an embodiment of carrying out VP interception through an internet protocol according to the present invention; and

FIG. 4 is a diagram illustrating another embodiment of carrying out VP interception in a CS field according to the present invention.

### DETAILED DESCRIPTION OF THE INVENTION

The following discussion is presented to enable a person skilled in the art to make and use the invention. The general principles described herein may be applied to embodiments and applications other than those detailed below without departing from the spirit and scope of the present invention as defined herein. The present invention is not intended to be limited to the embodiments shown, but is to be accorded the widest scope consistent with the principles and features disclosed herein.

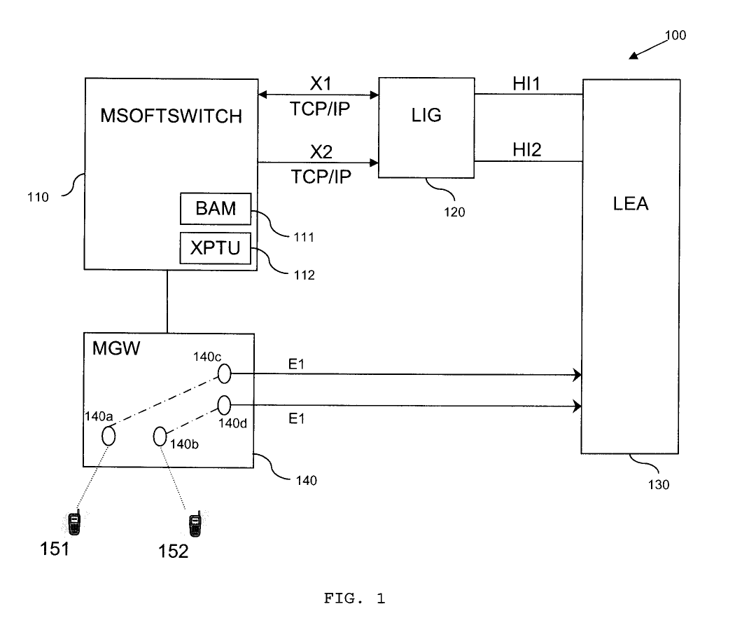

Reference is now made to FIG. 1, where a diagram (100) is illustrated for a conventional method of carrying out Video Phone (VP) interception in a Circuit Switched (CS) field. A Lawful Interception Gateway (LIG) (120) provides an intercept request source, e.g., a Law Enforcement Agency (LEA) (130), the ability to intercept calls within a Wideband Code Division Multiple Access (WCDMA) network. LEA (130) sends an interception request and interception related information to a Mobile Softswitch (MSOFTSWITCH) (110) via LIG (120). LIG (120) converts formats of control signaling between MSOFTSWITCH (110) and LEA (130). Communications between LIG (120) and LEA (130) are through Handover Interfaces (HI) HI1 and HI2. LIG (120) may be connected to multiple LEAs.

In addition, LIG (120) communicates with MSOFTSWITCH (110) through Transmission Control Protocol/Internet Protocol (TCP/IP) at interfaces X1 and X2. MSOFTSWITCH (110) contains a Back Administration Module (BAM) (111) and an X Protocol Transfer Unit (XPTU) (112). MSOFTSWITCH (110) instructs a Media Gateway (MGW) (140) to connect calls of users.

After a call between a user (151) and a user (152) is established, two ports (140a) and (140b) are allocated in MGW (140) to connect to users (151) and (152), receiving and delivering media streams of the users. When LEA (130) sends an request to MSOFTSWITCH (110), through LIG (120), that interception be performed on user (151), MSOFTSWITCH (110) allocates ports (140c) and (140d) in MGW (140), which may duplicate up media streams (media streams sent out by user (151)), and down media streams (media streams received by user (151), i.e. user (152)) of user (151), and send the up and down media streams to LEA (130), through an independent interface E1. Consequently, interception of user (151) in the WCDMA network is accomplished. If user (151) is using a VP call, then the up and down media streams may be H.233 multiplexing streams including audio and video media streams.

Conventional practices for VP interception using the method described above, or similar strategies, have drawbacks. Because capability information needs to be conveyed through control protocol H.245 in an initial stage of a VP call, an LEA is required to be able to resolve the H.245 protocol correctly, resulting in greater complexity. Because audio, video and control information in a VP call are transmitted to an LEA in one H.223 message packet, the LEA is required to support H.223 protocol, instead of just supporting a simple audio or video media stream. Furthermore, because an MGW only duplicates, not resolves, media streams, an LEA is required to resolve various media formats, demanding very high interoperability.

Consequently, in order to carry out VP interception, an LEA may have to meet the above requirements. Moreover, conventional LEAs only work for voice interception, and do not support video interception of VP services. In addition, conventional LEAs do not support protocols, such as H.245, H.223, etc. Thus, with these requirements and restrictions, conventional LEAs may not be able to perform voice interception of VP services.

The present invention provides voice interception for VP services in a multi-media communications network, without the need to change the conventional LEAs. The multi-media communications network may be a WCDMA network. In the present invention, upon receiving an interception request from an LEA, a MSOFTSWITCH may check whether a user to be intercepted is a VP user. If the user is a VP user, a conversion module may be provided in the network under the control of the MSOFTSWITCH. The conversion module may process media streams of the user's VP call traffic, and obtain audio media streams from the call traffic. The conversion module may be inside an MGW. The audio media streams may then be delivered to the LEA for interception.

The conversion module may be implemented in various ways and in different forms. Audio media streams may be delivered to an LEA through different interfaces, and an LEA may provide necessary interfacing information to an MSOFTSWITCH. The interception may also be initiated according to pre-defined configurations in the network. In this case, MSOFTSWITCH may provide the conversion module directly according to a pre-defined configuration. The present invention applies to, but not limited to, LEAs for voice interception of VP services. The present invention may be applied to other intercept request sources that function similarly to conventional LEAs, or that are readily apparent to those with ordinary skills in the art.

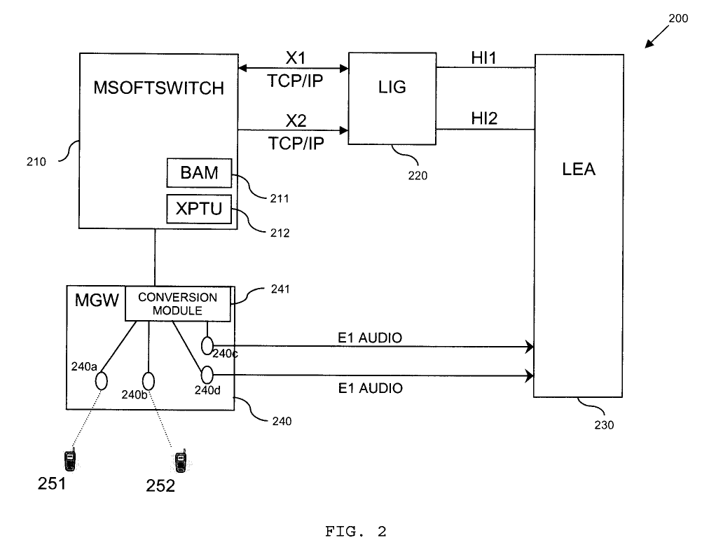

Referring now to FIG. 2, an embodiment of carrying out VP interception in a CS field is illustrated in a diagram (200) according to the present invention. Through an LIG (220), an MSOFTSWITCH (210) obtains, from an LEA (230), a request for interception of a user (251), and interception related information. The interception related information may include, for example, identification information of user (251), an interception type, and encoding and decoding codes.

User identification information may include an International Mobile Subscriber Identity (IMSI), an International Mobile Equipment Identity (IMEI), or a Mobile Station International ISDN Number (MSISDN) of user (251). ISDN means Integrated Services Digital Network. The interception type refers to type of media that an intercept request source requests to intercept. The media may be audio, video, data, or combination of these media. In this embodiment, the interception type may be voice. MSOFTSWITCH (210) contains a BAM (211) and an XPTU (212).

Two ports (240a) and (240b) in a MGW (240) are allocated to connect calls between user (251) and another user (252). Upon receipt of the interception request, MSOFTSWITCH (210) determines whether user (251) is using a VP call. If user (251) is using a VP call, MSOFTSWITCH (210) informs MGW (240) to provide a conversion module (241), which processes receiving and transmitting media streams of user (251).

MSOFTSWITCH (210) may also initiate interception of a user according to fixed or pre-defined configurations—wherein users of a certain VP number, a range of VP numbers, or all VP numbers may be set up for interception. Interception related information may also predefined in such configurations. These configurations are pre-defined based on an interception request from an intercept-authorized entity, and stored in the system. Once an intercept target (a user to be intercept) begins a VP call, interception is initiated using the target information contained in the pre-defined configurations. This may be useful for long-term interception purpose. Thus, interception is initiated based on the configurations, instead of a directly received interception request. That is, MSOFTSWITCH (210) may perform interception without directly receiving an interception request, and related information, from an LEA or other sources of intercept requests. In such instances, MSOFTSWITCH (210) may directly prompt MGW (240) to provide conversion module (241) for processing VP call traffic, according to a given configuration.

Conversion module (241) detaches H.245 messages from up and down media streams of user (251); delivers the H.245 messages up to MSOFTSWITCH (210); and decomposes the media streams under the control of MSOFTSWITCH (210), to separate audio and video media streams from an H.223 message packet. MGW (240) converts audio media streams into a format supported by LEA (230). Audio media streams are sent to ports (240c) and (240d) for delivery. MGW (240) establishes a voice channel between LEA (230) and MGW (240) under the control of MSOFTSWITCH (210), and delivers the audio media streams of user (251) to LEA (230), through an audio interface E1—thus carrying out voice interception of a VP user by LEA (230). In alternative embodiments, MGW (240) may communicate to multiple LEAs.

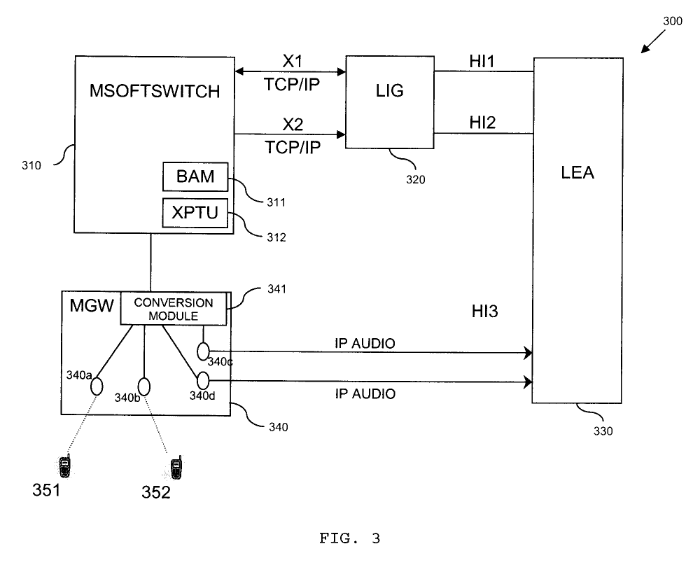

FIG. 3 illustrates a diagram (300) for one alternative embodiment of VP interception through an Internet Protocol (IP), according to the present invention. An LEA (330) conveys to an MSOFTSWITCH (310), through an LIG (320), interception related information. The interception related information includes an IMSI, an IMEI and an MSISDN of an intercept user (351), an interception type, encoding and decoding codes, and interface addresses of HI3 of LEA (330). The interception type may be voice, video, data, or combination of various media. HI3 is a handover interface for feeding call content to LEAs. The interface addresses of HI3 may include a Real-Time Transport Protocol (RTP) address, and a Real-Time Transport Control Protocol (RTCP) address. In this example, LEA (330) supports an IP interface. In addition, MSOFTSWITCH (310) contains a BAM (311) and an XPTU (312).

Ports (340a) and (340b) are allocated in an MGW (340) to communicate media streams between user (351) and another user (352). Determining that user (351) is using a VP call, MSOFTSWITCH (310) prompts MGW (340) to provide a conversion module (341) in MGW (340), which processes the receiving and transmitting media streams of user (351). Conversion module (341) detaches H.245 messages from up and down media streams of user (351), delivers the H.245 messages up to MSOFTSWITCH (310), and decomposes the media streams under the control of MSOFTSWITCH (310). Thus, audio and video media streams are separated from an H.223 message packet.

MGW (340) then converts the audio media streams into a format that is supported by LEA (330). Moreover, MSOFTSWITCH (310) allocates two IP ports (340c) and (340d) in MGW (340) corresponding to the up and down media streams of user (351), respectively. Addresses of the two IP ports are bound with that of HI3. Conversion module (341) of MGW (340) delivers the audio media streams to corresponding port (340c) or (340d), which in turn delivers the audio media streams to LEA (330) through interface HI3.

Thus, introducing a conversion module in a media gateway to obtain audio media streams from VP call traffic of an intercept target, the present invention provides voice interception of video phone services without requiring changes to conventional LEAs.

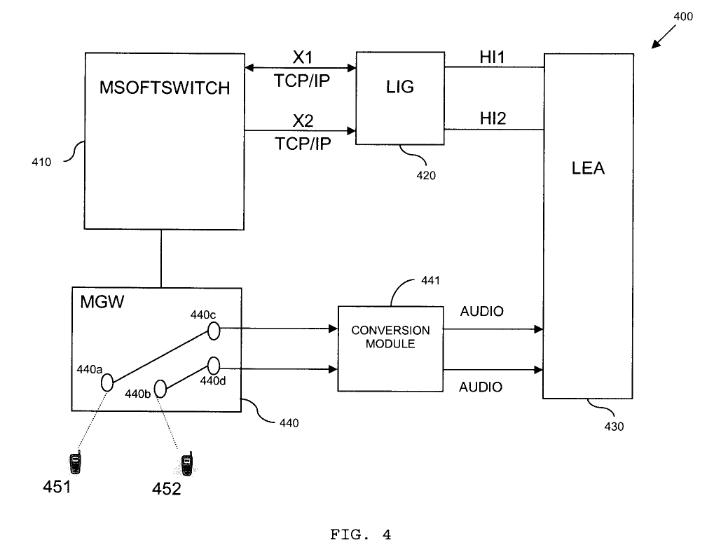

FIG. 4 illustrates a diagram (400) for another embodiment of VP interception in a CS field according to the present invention. The basic processes are the same as the previous two embodiments of the present invention. An MSOFTSWITCH (410) may receive an interception request on a user (451), and interception related information, from an LEA (430) through an LIG (420).

When a call between user (451) and a user (452) is established, ports (440a) and (440b) are allocated in MGW (440), to receive and deliver media streams of call traffic between the two users.

If user (451) is using a VP call, a conversion module (441) is provided under the control of MSOFTSWITCH (410). Conversion module (441) is associated with, but is not provided within an MGW (440). Conversion module (441) may be an independent module, as illustrated in FIG. 4, or may be a module within other components of a multi-media network. Conversion module (441) may communicate with MGW (440) via an interface E1 or IP.

The media streams are duplicated in port (440c) and (440d), and sent to conversion module (441) for processing. Conversion module (441) extracts audio data from the received media streams under the control of MSOFTSWITCH (410), and delivers the audio data to LEA (440) through an interface E1.

In this embodiment, a conversion module is provided outside of a given MGW. This independent conversion module may further be shared by multiple MGWS. This reduces MGW complexity, simplifies network structures, and lowers network cost.

The previous description of the disclosed embodiments is provided to enable those skilled in the art to make or use the present invention. Various modifications to these embodiments will be readily apparent to those skilled in the art and generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A system for voice interception of Video Phone (VP) services in a multi-media communications network, comprising:
at least one intercept request source;
a processing component, adapted to process communication traffic of at least one intercept target, to obtain audio data from the communication traffic; and
a media connection component, adapted to communicate the audio data with the at least one intercept request source.

2. The system of claim 1, wherein the media connection component converts the audio data into a format that is supported by the at least one intercept request source, and delivers the audio data to the at least one intercept request source.

3. The system of claim 1, wherein the voice interception is performed based on pre-defined configurations.

4. The system of claim 1, further comprising a control component, adapted to control voice interception.

5. The system of claim 4, wherein the control component is adapted to receive an interception request to perform interception on the at least one intercept target, and interception related information, from the at least one intercept request source.

6. The system of claim 5, wherein the interception related information comprises an International Mobile Subscriber Identity (IMSI), an International Mobile Equipment Identity (IMEI), a Mobile Station International Integrated Services Digital Network Number (MSISDN), an interception type, and encoding and decoding codes.

7. The system of claim 6, wherein the interception related information further comprises interface addresses of handover interfaces of the at least one intercept request source.

8. The system of claim 4, wherein the control component is adapted to determine whether the at least one intercept target is using a Video Phone call.

9. The system of claim 4, wherein the control component is adapted to provide pre-defined configurations for performing voice interception.

10. The system of claim 4, wherein the control component comprises a mobile softswitch.

11. The system of claim 1, wherein the at least one intercept request source comprises a Law Enforcement Agency (LEA).

12. The system of claim 11, wherein the audio data is communicated to the LEA through an interface E1.

13. The system of claim 11, wherein the Law Enforcement Agency supports an internet protocol.

14. The system of claim 13, wherein the audio data is communicated to the Law Enforcement Agency through an IP interface.

15. The system of claim 11, wherein the media connection component comprises a media gateway.

16. The system of claim 11, wherein the processing component comprises a conversion module.

17. The system of claim 16, wherein the conversion module is provided in a media gateway.

18. The system of claim 16, wherein the conversion module detaches H.245 messages from the communication traffic, delivers the H.245 messages up to a mobile softswitch, and decomposes the communication traffic under the control of the mobile softswitch, to obtain audio and video data from an H.223 message packet.

19. The system of claim 1, wherein the multi-media communications network comprises a Wideband Code Division Multiple Access (WCDMA) network.

20. A media gateway, for voice interception of video phone services in a multi-media communications network, comprising:
means for obtaining audio data, video data, and control information from communication traffic of a video phone call; and
means for communicating the audio data with an intercept request source.

21. The media gateway of claim 20, wherein the audio data is communicated through an interface E1.

22. The media gateway of claim 20, wherein the audio data is communicated through an internet protocol.

23. The media gateway of claim 20, wherein the intercept request source comprises a Law Enforcement Agency.

24. A system for voice interception of video phone services in a Wideband Code Division Multiple Access (WCDMA) network, comprising:
A Law Enforcement Agency;
a mobile softswitch, adapted to receive, from the Law Enforcement Agency, an interception request to perform interception on an intercept target, and interception related information, and adapted to control the voice interception;
a conversion module, adapted to process communication traffic of the intercept target to obtain audio data from the communication traffic; and
a media gateway, adapted to convert the audio data into a format supported by the Law Enforcement Agency, and to deliver the audio data to the Law Enforcement Agency through an interface E1;
wherein the interception related information comprises an International Mobile Subscriber Identity (IMSI), an International Mobile Equipment Identity (IMEI), a Mobile Station International Integrated Services Digital Network Number (MSISDN), an interception type, and encoding and decoding codes;
wherein the conversion module is provided in the media gateway if the intercept target is using a video phone call;
wherein the conversion module detaches H.245 messages from the communication traffic, delivers the H.245 messages up to the mobile softswitch, and decomposes the communication traffic under the control of the mobile softswitch, to obtain audio and video data from an H.223 message packet.

25. A method for voice interception of Video Phone (VP) services in a multi-media communications network, comprising the steps of:
processing communication traffic of at least one intercept target, to obtain audio data from the communication traffic; and
communicating the audio data with at least one intercept request source.

26. The method of claim 25, wherein the step of communicating further comprises: converting the audio data into a format that is supported by the at least one intercept request source; and delivering the audio data to the at least one intercept request source.

27. The method of claim 25, wherein the voice interception is performed based on pre-defined configurations.

28. The method of claim 27, wherein a mobile softswitch is adapted to provide the pre-defined configurations.

29. The method of claim 25, further comprising determining whether the at least one intercept target is using a video phone call.

30. The method of claim 25, further comprising receiving an interception request to perform interception on the at least one intercept target, and interception related information, from the at least one intercept request source.

31. The method of claim 30, wherein a mobile softswitch is adapted to receive the interception request and interception related information.

32. The method of claim 30, wherein the interception related information comprises an International Mobile Subscriber Identity (IMSI), an International Mobile Equipment Identity (IMEI), a Mobile Station International Integrated Services Digital Network Number (MSISDN), an interception type, and encoding and decoding codes.

33. The method of claim 32, wherein the interception related information further comprises interface addresses of handover interfaces of the at least one intercept request source.

34. The method of claim 25, wherein the at least one intercept request source comprises a Law Enforcement Agency (LEA).

35. The method of claim 34, wherein the audio data is communicated to the Law Enforcement Agency through an interface E1.

36. The method of claim 34, wherein the Law Enforcement Agency supports an internet protocol.

37. The method of claim 36, wherein the audio data is communicated to the Law Enforcement Agency through an internet protocol interface.

38. The method of claim 34, wherein a Media Gateway (MGW) is adapted to communicate the audio data with the Law Enforcement Agency.

39. The method of claim 38, wherein the Media Gateway converts the audio data into a format that is supported by the Law Enforcement Agency, and delivers the audio data to the Law Enforcement Agency.

40. The method of claim 34, wherein a processing component is adapted to process the communication traffic of the at least one intercept target to obtain audio data.

41. The method of claim 40, wherein the processing component comprises a conversion module.

42. The method of claim 41, wherein the conversion module is provided in a media gateway.

43. The method of claim 41, wherein the conversion module detaches H.245 messages from the communication traffic, delivers the H.245 messages up to a mobile softswitch, and decomposes the communication traffic under the control of the mobile softswitch, to obtain audio and video data from an H.223 message packet.

44. The method of claim 25, wherein the multi-media communications network comprises a Wideband Code Division Multiple Access (WCDMA) network.
